(19) United States
(12) Patent Application Publication
(10) Pub. No.: US 2019/0251853 A1
(43) Pub. Date: Aug. 15, 2019

(54) INTERACTIVE EXPECTATION-BASED TRAINING SYSTEM AND METHOD

(71) Applicant: TARGET GROUP INC., VAUGHAN (CA)

(72) Inventors: RUBIN SCHINDERMANN, ONTARIO (CA); SASHA STARR, ONTARIO (CA); MARTY D. HIRSCH, ONTARIO (CA)

(73) Assignee: TARGET GROUP INC., VAUGHAN, ON (CA)

(21) Appl. No.: 16/315,772

(22) PCT Filed: Jul. 8, 2016
(86) PCT No.: PCT/CA2016/050803

§ 371 Date: Jan. 7, 2019

(51) Int. Cl. G09B 5/06; G09B 19/00

(52) U.S. Cl. CPC G09B 5/06; G09B 19/22; G09B 19/00

(57) ABSTRACT

An interactive training system for at least one participant, said system comprising: an activity module for generating at least one training session based on a primary activity performed by at least one expert; an environment module for providing at least one training scenario for said primary activity; an input module for enabling said at least one participant to register an expectation of each expert decision, including a stake corresponding to his degree of confidence in said expectation; a feedback module for providing feedback to said at least one participant regarding said expectation said at least one participant enters or fails to enter and for determining a reward or penalty based on said expectation.

### FIELD OF THE INVENTION

The present invention relates to an interactive training system and method.

### DESCRIPTION OF THE RELATED ART

Learning tools and sources of instructional information for learning a new activity are well known. In classroom environments attention tends to wander and when instruction is delivered verbally, with or without visual aids, individuals often do not focus closely enough, or are not attentive enough, to internalize the thought processes needed to make correct decisions in demanding situations.

Currently, a plurality of learning tools and methods are available in the market including software learning systems operating in a computerized environment. However, none of the existing tools or methods adequately fosters internalization of the thought processes needed to respond effectively in evolving situations. Existing methods often fail to provide motivation to focus sufficiently on the procedures and information that need to be learned. Furthermore, existing tools are often insufficient to motivate newcomers to sustain their interest in an intellectually demanding pursuit, such as chess. In summary, existing tools and methods are generally poor at training individuals to act or respond appropriately in challenging situations, are weak at motivating interest in an intellectually demanding pursuit, and are often unable to measure responses quantitatively.

It is thus an object of the present invention to mitigate or obviate at least one of the above-mentioned disadvantages.

### SUMMARY OF THE INVENTION

In one of its aspects, there is provided an interactive training system for at least one participant, said system comprising:
an activity module for generating at least one training session based on a primary activity performed by at least one expert;
an environment module for providing at least one training scenario for said primary activity;
an input module for enabling said at least one participant to register an expectation said at least one expert's decision, including a stake corresponding to his degree of confidence in said participant's expectation;
a feedback module for providing feedback to said at least one participant regarding said expectation said at least one participant enters or fails to enter; and for determining a reward or penalty based on said expectation.

In another of its aspects, there is provided a computer-implemented method for training at least one participant in an activity, said method comprising:
generating at least one training session based on an activity performed by at least one expert;
providing at least one training scenario for said activity;
enabling said at least one participant to register an expectation of said at least one expert's decision, including a stake corresponding to his degree of confidence in said expectation;
providing feedback to said at least one participant regarding said expectation said at least one participant enters or fails to enter; and
determining a reward based on said expectation and said stake.

In another of its aspects, there is provided an interactive training system for at least one participant, said system comprising:
an activity module comprising a second set of program instructions executable by said processor to cause said processor to generate at least one training session based on a primary activity performed by at least one expert;
an environment module comprising a first set of program instructions executable by a processor to cause said processor to provide at least one training scenario for said primary activity;
an input module comprising a third set of program instructions executable by a processor to cause said processor to enable said at least one participant to register an expectation of said at least one expert's decision, including a stake corresponding to his degree of confidence in said expectation;
a feedback module comprising a fourth set of program instructions executable by said processor to cause said processor to provide feedback to said at least one participant regarding said expectation said at least one participant enters or fails to enter; and to determine a reward or penalty based on said expectation and said stake.

Advantageously, participants are trained while observing real situations, or simulations thereof, in a chosen activity, and are prompted to make decisions or responses within a predetermined time period, or before decisions are made by experts. The decisions of the participants are subsequently compared to the experts' decisions and the outcome of the comparison is presented to the participants as feedback. Accordingly, participants are not trained primarily to absorb facts, and are not graded according to how much they can recall. Furthermore, the training concepts are not presented in isolation, but instead each activity is followed, stage by stage, to its conclusion. The feedback is relatively fast, calibrated, and specific to each decision. Unlike conventional testing methods in which examinations are conducted, graded, and the results issued later, the feedback provided by the present system is neither delayed nor commingled with feedback on other decisions. This not only makes the feedback more effective, but also serves to reinforce not just the skills and information that are taught, but also the participant's receptivity to learning those skills, and to absorbing that information.

In addition, the methods and systems use interactive environments to implement techniques derived from behavioral psychology. The interactive expectation-based training system generates feedback by measuring participants' ability to anticipate decisions made by experts. Furthermore, the system delivers timely, calibrated rewards for correct responses, thereby increasing not only participation, but also investment in the learning experience. Accordingly, the methods and systems are suitable for training in disciplines in which a discrete action must be chosen at each stage.

Exemplary disciplines to which the system for interactive training is applicable include medical procedures, responses to industrial or transportation emergencies, and other activities in which an unpredictable sequence of events may occur and expertise is needed to make appropriate decisions at each stage of the response. In general, medical procedures are not predictable, because the physiology and morbidity of each patient differ from those of the next, and decisions need to be made in an expeditious manner. The system described herein assists participants to focus on the training activity, and develop their decision-making abilities while absorbing information from the expert decisions made in each scenario, as well as from the verbal instruction and visual aids that are also provided.

### BRIEF DESCRIPTION OF THE DRAWINGS

Several exemplary embodiments of the present invention will now be described, by way of example only, with reference to the appended drawings in which:

FIG. 1 shows an exemplary computing system;

FIG. 2 shows an exemplary environment in which a method and system for interactive training operate;

FIGS. 3a and 3b show a high level flow diagram illustrating exemplary process steps for interactive training;

FIG. 4 is an exemplary registration screen of a user interface;

FIG. 5 is an exemplary login screen of a user interface;

FIG. 6 is a screenshot of an exemplary user interface for interactive chess training;

FIGS. 7a and 7b show a high level flow diagram illustrating exemplary process steps for interactive training; and

FIGS. 8a to 8d show various screenshots of the exemplary user interface for interactive chess training in progress.

### DETAILED DESCRIPTION OF EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

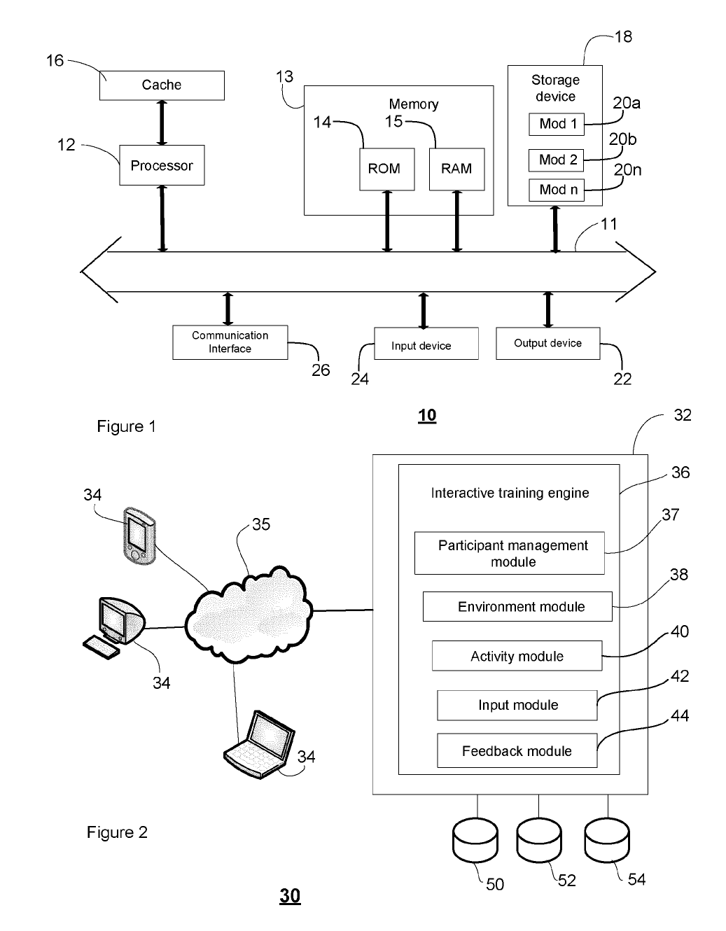

With reference to FIG. 1, an exemplary computing system 10 includes a general-purpose computing device 10, including a processing unit (CPU or processor) 12 and a system bus 11 that couples various system components including the system memory 13 such as read only memory (ROM) 14 and random access memory (RAM) 15 to the processor 12. The system 10 can include a cache 16 of high speed memory connected directly with, in close proximity to, or integrated as part of the processor 12. The system 10 copies data from the memory 13 and/or storage device 18 to the cache 16 for quick access by the processor 12. In this way, the cache provides a performance boost that avoids processor 12 delays while waiting for data. These and other modules can control or be configured to control the processor 12 to perform various actions. Other system memory 13 may be available for use as well. The memory 13 can include multiple different types of memory with different performance characteristics. It can be appreciated that the methods and system may operate on a computing device 10 with more than one processor 12 or on a group or cluster of computing devices networked together to provide greater processing capability. The processor 12 can include any general purpose processor and a hardware module or software module, such as module 1 20a, module 2 20b, and module n 20n stored in storage device 18, configured to control the processor 12 as well as a special-purpose processor where software instructions are incorporated into the actual processor design. The processor 12 may essentially be a completely self-contained computing system, containing multiple cores or processors, a bus, memory controller, cache, etc. A multi-core processor may be symmetric or asymmetric.

The system bus 11 may be any of several types of bus structures including a memory bus or memory controller, a peripheral bus, and a local bus using any of a variety of bus architectures. A basic input/output (BIOS) stored in ROM 14 or the like, may provide the basic routine that helps to transfer information between elements within the computing device 10, such as during start-up. The computing device 10 further includes storage devices 18 such as a hard disk drive, a magnetic disk drive, an optical disk drive, a solid state drive, a tape drive or the like. The storage device 18 can include software modules 20a, 20b, and 20n for controlling the processor 12. Other hardware or software modules are contemplated. The storage device 18 is connected to the system bus 11 by a drive interface. The drives and the associated computer readable storage media provide non-volatile storage of computer readable instructions, data structures, program modules and other data for the computing device 10. In one aspect, a hardware module that performs a particular function includes the software component stored in a non-transitory computer-readable medium in connection with the necessary hardware components, such as the processor 12, bus 11, display 22, and so forth, to carry out the function. The basic components are known to those of skill in the art and appropriate variations are contemplated depending on the type of device, such as whether the device 10 is a handheld computing device, a desktop computer, or a computer server.

Although the exemplary embodiment described herein employs the hard disk 18, it should be appreciated by those skilled in the art that other types of computer readable media which can store data that are accessible by a computer, such as magnetic cassettes, flash memory cards, digital versatile disks, cartridges, random access memories (RAMs) 15, read only memory (ROM) 14, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 10, an input device 24 represents any number of input mechanisms, such as a microphone for speech, a touch-sensitive screen for gesture or graphical input, keyboard, mouse, motion input, speech and so forth. An output device 22 can also be one or more of a number of output mechanisms known to those of skill in the art. In some instances, multimodal systems enable a user to provide multiple types of input to communicate with the computing device 10. The communications interface 26 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks, including functional blocks labeled as a “processor” or processor 12. The functions these blocks represent may be provided through the use of either shared or dedicated hardware, including, but not limited to, hardware capable of executing software and hardware, such as a processor 12, that is purpose-built to operate as an equivalent to software executing on a general purpose processor. For example, the functions of one or more processors, presented in FIG. 1, may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 14 for storing software performing the operations discussed below, and random access memory (RAM) 15 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 10, shown in FIG. 1, can practice all or part of the recited methods, can be a part of the recited systems, and/or can operate according to instructions in the recited non-transitory computer-readable storage media. Such logical operations can be implemented as modules configured to control the processor 12 to perform particular functions according to the programming of the module. For example, FIG. 1 illustrates three modules 20a, 20b and 20n which are modules configured to control the processor 12. These modules 20a, 20b and 20n may be stored on the storage device 18 and loaded into RAM 15 or memory 13 at runtime or may be stored, as would be known in the art, in other computer-readable memory locations.

Computer system 10 can be of varying types including a workstation, server, computing cluster, blade server, server farm, or any other data processing system or computing device. Due to the ever-changing nature of computers and networks, the description of computer system 10 depicted in FIG. 1 is intended only as a specific example for purposes of illustrating some implementations. Many other configurations of computer system 10 are possible having more or fewer components than the computer system depicted in FIG. 1.

FIG. 2 shows a top-level component architecture diagram of an exemplary system, generally identified by reference numeral 30, for which the method for interactive expectation-based training operates. As shown, FIG. 2 illustrates system 30, in which a user interacts with computing system 32, such as a processing server, through user computer 34 communicatively coupled thereto via communication medium 35, or network, e.g., the Internet, and/or any other suitable network. The computers of environment 30 comprise the features of the general-purpose computing device 10, as described above, and may include, but are not limited to: a mini computer, a handheld communication device, e.g. a tablet, a mobile device, a smart phone, a smartwatch, a wearable device, a personal computer, a server computer, a series of server computers, and a mainframe computer.

The processing server apparatus 32 comprises interactive training engine 36 with plurality of modules, such as participant management module 37; environment module 38; activity module 40, input module 42, and feedback module 44. Application server 32 is associated with one or more databases, such as participant information database 50, session database 52, rewards database 54, which may be any type of data repository or combination of data repositories, which store records or other representations of data associated with the participants, training sessions, events, rewards, penalties, statistics, and so forth.

Generally, system 30 promotes engagement with training exercises, and teaches appropriate responses within those exercises, by providing an interactive environment that motivates participants to participate in a “meta-activity” in which feedback is based on each participant's expressed expectations of expert decisions in an observed primary activity. As used herein, primary activity refers to a situation in which decisions must be made, such as a medical procedure. The activity can either be pre-recorded, or it can occur in real time, and each decision point is called a stage.

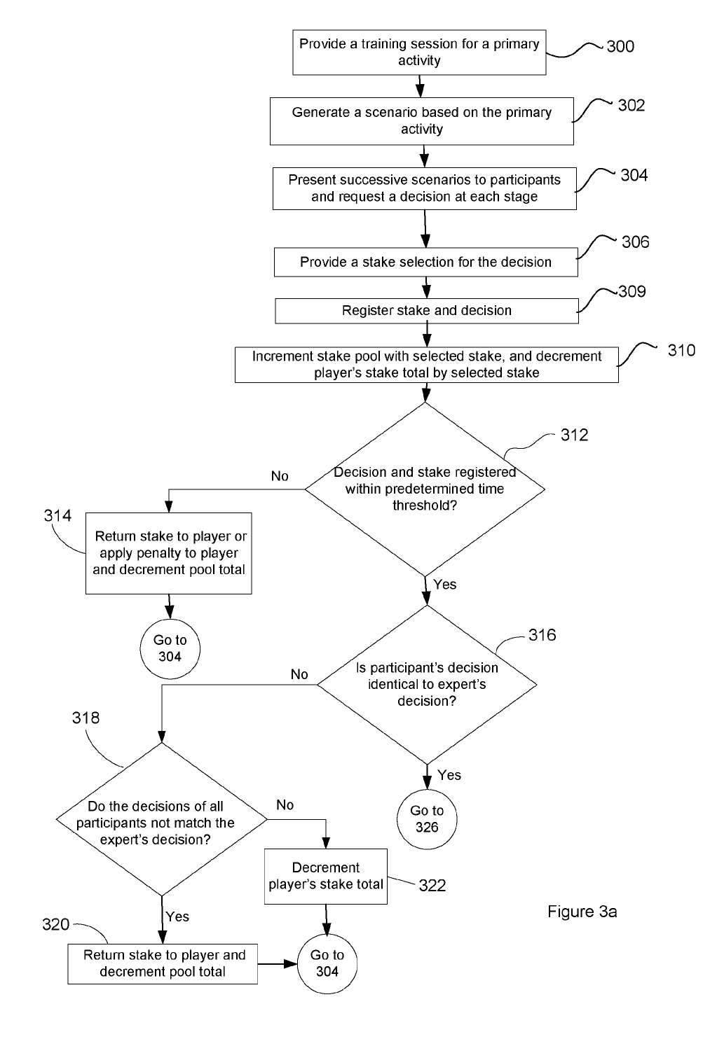

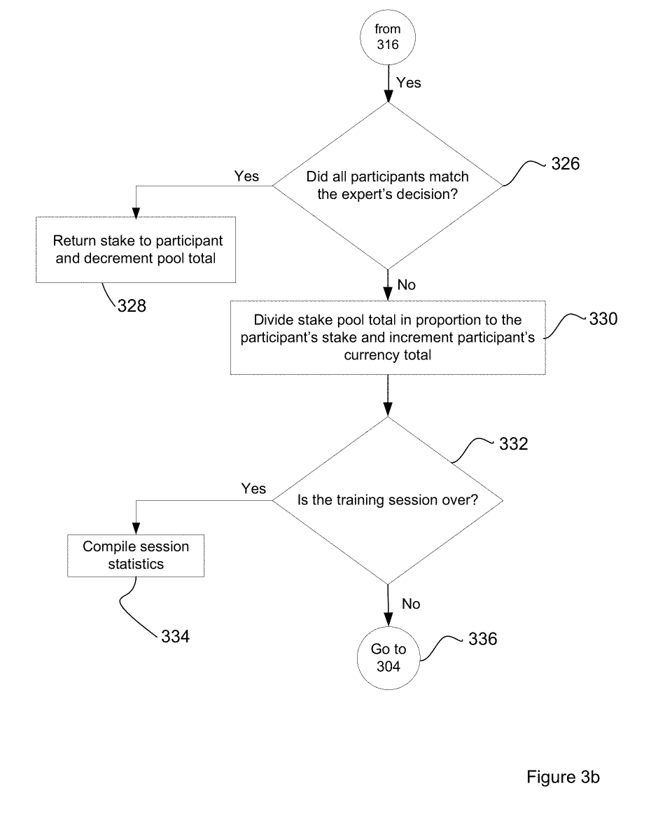

The interactive expectation-based training method will now be described with reference to FIGS. 3a and 3b which show exemplary method steps for interactive training in a primary activity. In step 300, environment module 38 delivers various types of content specific to each training session, such as, a scenario, verbal instruction, and visual aids that present additional information relevant to the decision-making process in each situation. Accordingly, the environment module 38 provides a sequence of related situations, or scenarios, in which decisions are to be made by a participant, and by at least one expert, in dealing with the given type of situation. For example, the scenarios may be rendered either as still images or as moving pictures. These images or pictures may be enacted (as in a movie), simulated, computer-generated, pre-recorded, edited, or they may be streaming images of actual events, displayed in near real-time. The scenarios may also be computer-generated representations of either fictional or real events. If real events are represented, these can either be past events, or current events that are represented in near real-time.

Regardless of the visual form the scenario takes, the essence of the scenario component of the environment module 38 is the depiction of a sequence of related situations in which decisions are desired. Each scenario concludes with an expert decision, and the outcome of that decision leads to the next scenario. Another component of the environment module 38 is verbal instructions, which can be broadcast through an audio channel accessible to each participant. Alternatively, the verbal instructions may be delivered by an instructor present in the same room with the participants. Yet another component of the environment module 38 is visual aids, which can include charts, graphs, statistics, definitions, specific information or expert opinions. Generally, visual aids consist of additional information, relevant to the decision-making process at each stage, displayed where each participant can see them. The same set of visual aids is visible to each participant. These scenarios are subsequently presented on user device 34 via a display screen, speakers, or via a television or movie screen, such that a participant is able to observe and/or listen to the scenario. Participants may also hear and observe instructional materials or educational information.

In step 302, activity module 40 generates scenarios based on the primary activity. In operation, activity module 40 provides some of the data to environment module 38 for presentation. The data provided by activity module 40 includes stages, options, and transitions that are displayed to the participants. The functions of activity module 40 may either be automated, or may be manually controlled, in which case the stage boundaries and the sets of decisions that are available at each stage are human-generated. The stages are the successive situations in which decisions must be made (step 304). In each stage participants observe the scenario for that stage, view the visual aids, and listen to verbal instructions appropriate to the scenario at hand. In each stage options are presented which indicate decisions that can be made in the given situation. In general these are presented as a set of radio buttons from which the participant may select, and generally only one option, or decision, may be selected at each stage.

Input module 42 provides a plurality of tools that participants can use to predict the expert's decision and to register their expectation of each expert decision, as well as the participant's degree of confidence in each of the predicted decision. Accordingly, input module 42 provides the participant with a selection of stakes, and the participant is prompted to choose a stake to indicate the participant's degree of confidence in the decision to be registered (step 306). Accordingly, input module 42 is configured to provide sufficient currency to every participant at the beginning of each stage, to allow the participant to assign a stake for each decision in any given stage. Without this mechanism, participants might at times be unable to post a stake sufficient to enter a decision, and this would impair the motivational utility of the training configuration.

Motivation is likely to be optimized by using a representational currency and later providing actual rewards both for the best result in each specific training session, and also for the best aggregated results over a series of such sessions. The reason is that this mechanism motivates participants to continue to focus on the activity, and continue to give deliberate consideration to every decision they make throughout a training session, even if they have performed poorly in the earlier stages of a given session.

In step 308, the decision and stake are registered, and once entered the decision and stake cannot be changed by the participant. This models the real-world consideration that decisions, once made, cannot be normally undone. Stakes are defined in units of the training system currency, which is also used for rewards, as determined by feedback module 44. Next, input module 42 receives the participant's stake and increments the selected stake to a stake pool with stakes from other participants at that stage, and decrements the selected stake from the participant's currency total (step 310). The total stake pool available at each stage is the sum of a start value, plus the sum of the stakes entered for all of the decisions attempted at that stage.

Subsequently, the expert makes a decision in the primary activity and the expert's decision is received by feedback module 44, and then no further decisions are accepted from participants during the current stage. Therefore, in step 312 feedback module 44 receives the decision and stake from each participant and determines whether the participant's decision and stake were received before receipt of the decision by the expert, or within a predetermined time period. When the decision and stake are not received within the prescribed time period, or after the expert's decision, then the stake is returned to the participant, or the participant is penalized. The pool total is decremented by the stake amount initially selected by the participant (step 314) and the participant waits for the next prompt to make a decision in the next stage (at step 304). Generally, failing to enter a selection may count as an incorrect decision, and a predetermined stake sum may be forfeited for each such occurrence. Alternatively, system 30 may allow participants to forgo the opportunity to enter a selection at some or all of the stages of a training session, without penalty. However, if the decision and stake are received before the expert's decision occurs, then feedback module 44 compares the decision entered by the participant to the decision made by the expert to determine whether the participant's decision is identical to the decision by the expert (step 316).

When the participant's decision is not identical to the decision by the expert, then feedback module 44 determines whether all of the other participants also made a decision that was different from the expert's decision (step 318). When all of the other participants also fail to match the decision by the expert then all of the participants' stakes for that decision are returned to their respective participants (step 320), and the stake pool total is decremented accordingly, else the participant's currency total is decremented by an amount corresponding to the selected stake amount at that stage (step 322), and the participant waits for the start of the next stage (at step 304).

When the participant's decision is identical to the decision by the expert then feedback module 44 determines whether all of the other participants also matched the expert's decision (step 326). A correct decision is defined as one that matches an expert's decision in the given situation. When all of the other participants' decisions also match the expert's decision then all of the participants' stakes for that stage are returned to the respective participants (step 328), and the stake pool total is decremented accordingly, else feedback module 44 divides the pool total in proportion to the participant's stake amount for that decision and increments the participant's currency total (step 330). Therefore, the value of the reward is intrinsically tied to the difficulty of the decision and is dependent on the percentage of participants with a correct decision or incorrect decision.

In addition, environment module 38 in conjunction with feedback module 44 displays to each participant the stake amount the participant has won or lost in each stage. If one participant wins the entire pool, the participant's name is displayed to all of the participants as the winner of that stage, which provides an additional motivating factor to reinforce active participation in the training exercise. If several of the participants divide the current award pool, this information is also provided to all of them, with or without any names of the participants being displayed. In addition, the overall leaders for the session are named at the end of each stage, which spurs competition and a human desire for recognition.

Next, activity module 40 determines whether the training session is over (step 332), and when the training session is over then activity module 40 determines each participant's performance and compiles training session statistics for each participant, and also determines particular prizes for certain participants (step 334). Winners in that training session, and the overall leaders for any aggregate awards, are also displayed to all of the participants. These various forms of feedback are intended to reinforce engagement in, and attention to, the training exercise and the learning that can be derived from participating in it. For example, one particular prize is awarded to the participant with the highest number of decisions matching the expert's decision, while other prizes are awarded at the end of predetermined time period, such as at the end of each month, for the most successful participants. If, in step 332, it is determined that the primary activity is still in progress, then the process returns to step 304. Therefore, a decision that is made by the expert affects the primary activity, for better or worse, and this marks a transition from one stage to the next. Once the feedback is generated and presented, the scenario rolls over to the subsequent stage. If the primary activity is a medical procedure, for example, the environment module 38 may present streaming video that rolls forward in near-real-time. This way the training exercise resembles what is experienced by interns who observe an experienced surgeon conduct a procedure.

Therefore, feedback module 44 provides feedback to each participant regarding every decision the participant enters or fails to enter. The feedback is calibrated both to the difficulty of each decision, and also to the participant's expressed degree of confidence in his decision.

In addition to the activity, the decisions, and the feedback, verbal and/or visual instruction may also be presented during training to provide information that participants may use both to help them formulate their decisions during a session and also to learn information and/or to internalize thought processes that improve their responses in future stages or sessions, or in practice when they apply the training to decision-making in the field of the activity. Stakes and rewards may either be tangible, representative, or representative and also exchangeable for rewards with tangible values. The feedback system promotes both engagement in the training sessions, and investment in the learning process. Participation is active, rather than passive, and attention is heightened by the speed, accuracy, and reinforcement value of the feedback.

In one exemplary application, the primary activity in a training session is a game of chess played between two experts, in which one plays with the white pieces, and the other plays with the black pieces on a chessboard. Each stage is a new position on the chessboard, which is seen by all of the participants. The decision options are represented as the set of legal moves in each position, and participants use a mouse or other pointing device to enter any move that is legal, according to the rules of chess, in that position. Once entered, a participant's decision cannot be changed nor retracted. Transitions occur when a new position is reached after either expert executes an actual move in the game. This changes the position in the game, and the ensuing position, which presents a new set of options i.e. legal moves for the opposite color in the new position, is then displayed to the participants, indicating the start of the next stage.

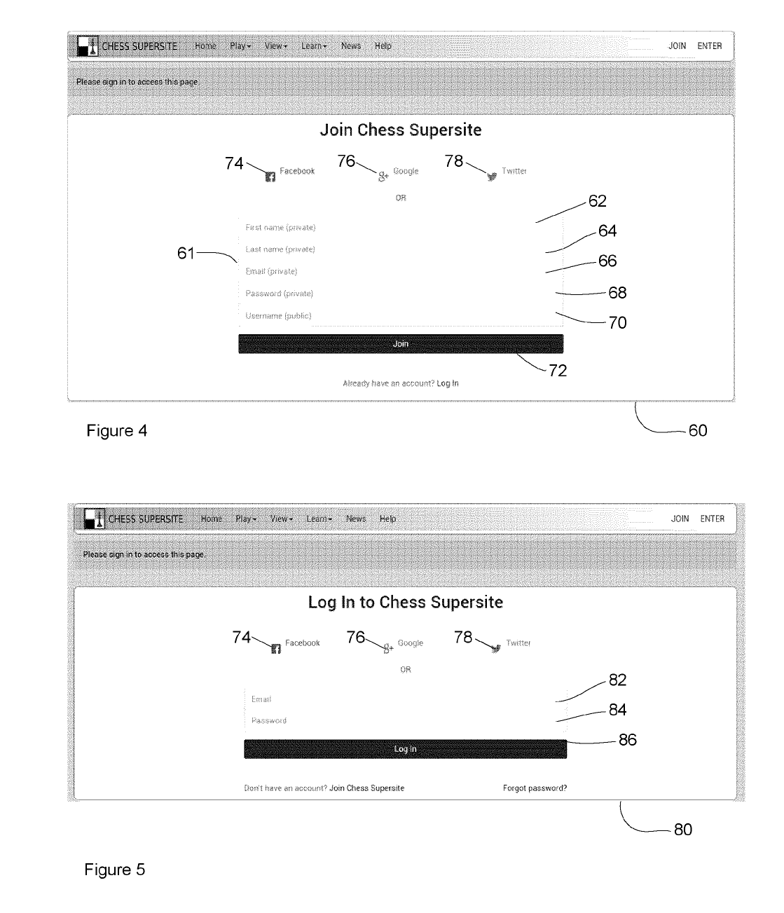

An exemplary training process for a game of chess will now be described with reference to FIGS. 4 to 8. Looking at FIG. 4, a participant is presented with exemplary screen 60 on graphical user interface display 22 of user device 34 in order to register with system 30. Exemplary screen 60 includes form 61 which allows data entry of the participant's first name in input field 62, the participant's last name in input field 64, the participant's email address in input field 66, the participant's password in input field 68, and username in input field 70. With fields 62 to 70, a user-selectable join icon 72 allows the user to submit the contents of form 61 to participant management module 37. Alternatively, the participant can sign up by logging in via a social networking site, such as Facebook, Twitter and Google+, by selecting a corresponding icon 74, 76 or 78, respectively. Each participant is assigned a unique identifier or participant ID, which is associated with the user credentials and stored in participant information database 50.

Once a participant has been registered by participant management module 37, any subsequent access to participate on games running on processing server apparatus 32 requires the participant to enter access credentials created at registration into email address input field 82 and password input field 84, or log in via using social networking site credentials, as shown in FIG. 5. Access is denied unless an authorized user name and corresponding password are entered into the appropriate fields 82, 84 or authentication is validated through social networking. A user-selectable login icon 86 allows the user to submit the user name and password for authentication/verification. Alternatively, the participant can login using social networking site credentials, such as Facebook, Twitter and Google+, by selecting a corresponding icon 74, 76 or 78, respectively.

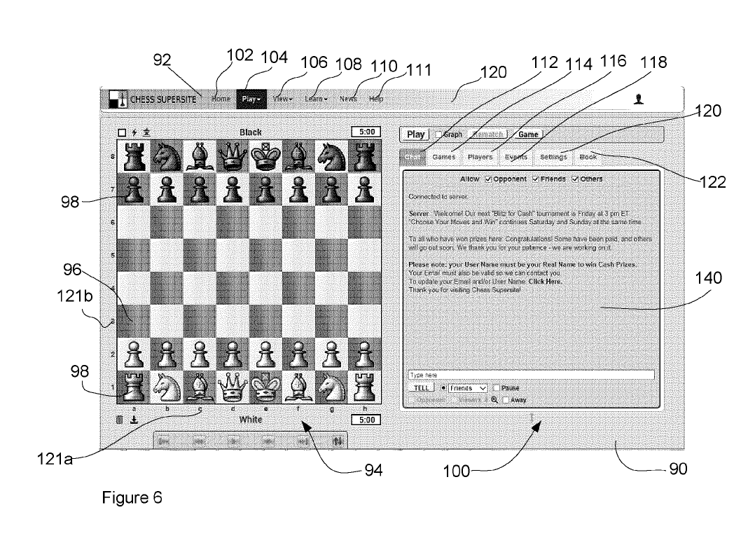

Upon successful authentication and verification of the participant credentials by participant management module 37, in conjunction with participant information database 50, screen 90 is presented on graphical user interface display 22. As shown in FIG. 6, screen 90 comprises menu bar 92, chess game portion 94 displaying a representation of a chess board 96 with a plurality of chess pieces 98, and game summary portion 100 associated with information pertaining to the participant (s) and the games. Menu bar 92 comprises home tab 102, play tab 104, view tab 106, news tab 108 and help tab 110, and game summary portion 100 comprises chat tab 112, games tab 114, players tab 116, events tab 118, setting tab 120 and book tab 122.

Generally, in a conventional method of playing chess, two players alternatively move chess pieces on a game board (playing field) comprising 64 equal squares of alternating light and dark colors. Chess clocks are used to limit the time for thinking over the moves in chess competitions, each of the chess clocks having a timing unit connected to two displays and a control unit. At the start of the game each player has the same number of chess pieces and pawns, one player having light-color (white) pieces and the other player having dark-color (black) pieces. Each set of chess pieces includes: one king, one queen, two rooks, two bishops, two knights and eight pawns. White starts the game; the right to play with white pieces is generally decided by a game of chance. A player must move one piece at a time, with the exception of castling. According to the rules of algebraic chess notation, field 121a comprises letters of Latin alphabet (from “a” to “h”), and field 121b comprises ciphers (from “1” to “8”), as shown in FIG. 6. In addition, each chess piece has its letter notion: King K, Queen Q, rook R, bishop B, knight N; notation p for pawns is used only to record positions, and omitted in records of the game. The chess moves are recorded by feedback module 44 using standard algebraic notation, and the games are recorded using the Portable Game Notation (PGN).

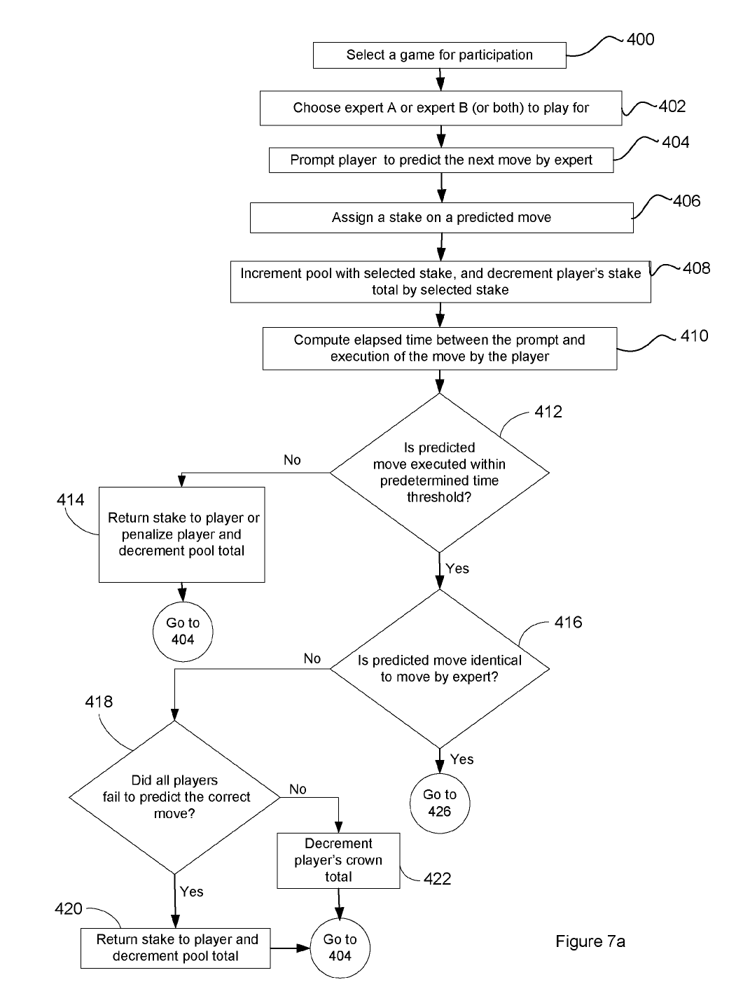

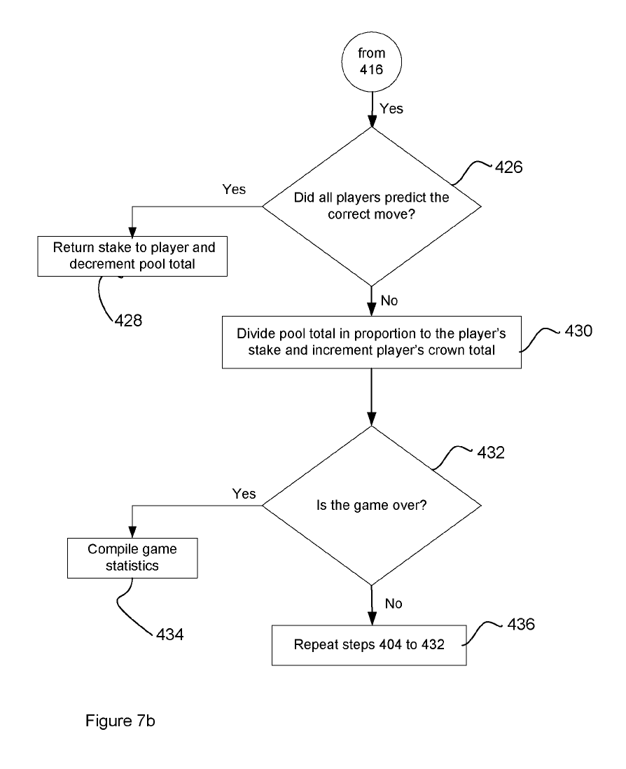

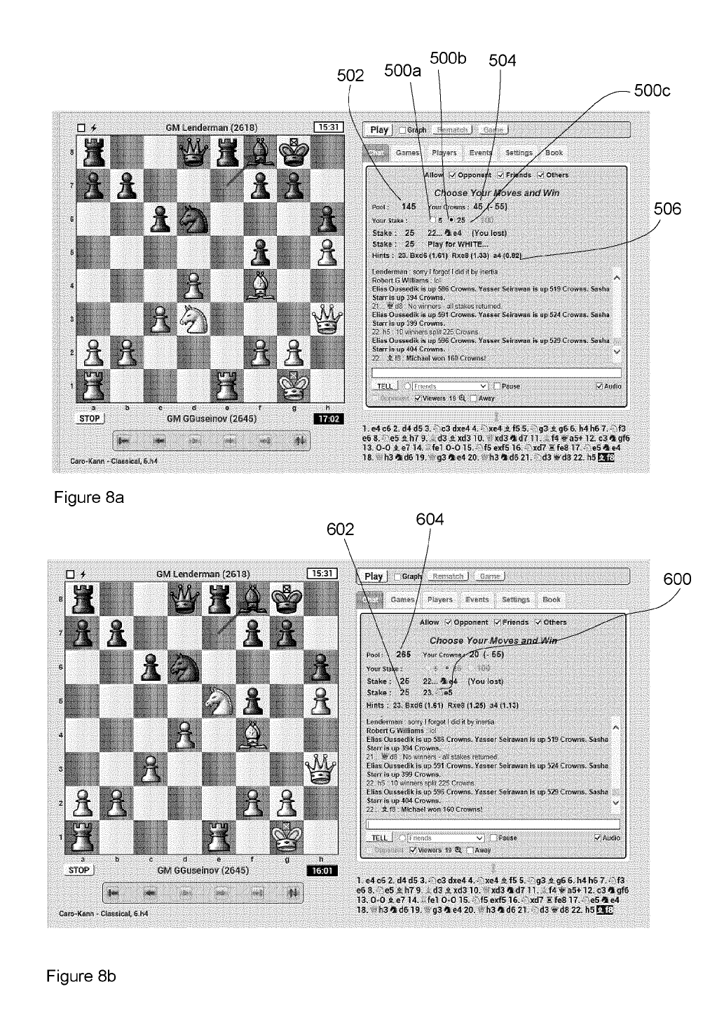

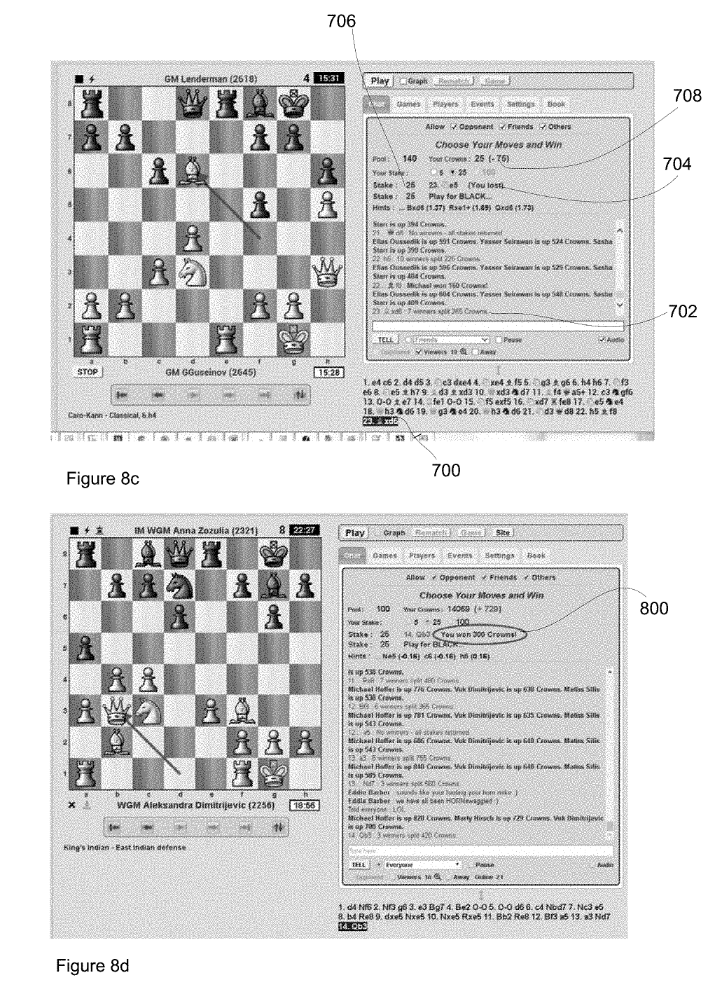

Exemplary steps for interactive training will now be described with reference to FIGS. 7a, 7b, 8a, 8b, 8c, and 8d. FIGS. 7a and 7b show the exemplary method steps for interactive training in which the primary activity is represented as a game of chess between expert players, viewed in near-real-time. Each stage, or scenario, is the position on the chessboard before the next move is executed. The decisions are the choices of which moves to play next. After each participant either enters a decision or runs out of time to do so, a real move is played by one of the expert players, which constitutes the expert decision that is executed in the given scenario. This decision changes the position on the board, and the outcome of that decision is the ensuing position, which becomes the next scenario.

Following participant authentication and verification, the participant selects a contest game listed in the Events tab 118. For example, if the game is between expert player A (black pieces) and expert player B (white pieces), the participant chooses whether to play for expert player A or expert player B, or both (step 402). Next, once the actual game (the primary activity) begins, the participant is prompted to predict the next move by expert player B by moving a chess piece 98 to a desired position on chess board 96 (step 404) before the time in which this can be done expires.

Accordingly, the participant uses a pointing device e.g. a mouse or finger to enter a move prediction before it is played. The participant is then prompted to assign a stake on a predicted move by assigning tokens of varying denominations or crowns (step 406). The crowns are a virtual currency used to participate in chess contests. In one example, a participant is allocated a predetermined number of crowns for joining the site, or for each day the participant plays at least one live chess game, or for entering a contest, or for each move played in a contest the participant participates in. For instance, a participant may be allocated 100 crowns for joining the site, 10 crowns for each day the participant plays at least one live chess game, 20 crowns for entering a contest, and 5 crowns for each move played in a contest the participant participates in.

As shown in FIG. 8a, the currency for assigning stakes is called “Crowns” and is purely representational. The stake is chosen via actuation of either radio button 500a associated with 5 crowns, radio button 500b associated with 25 crowns or radio button 500c associated with 100 crowns. Stake selection can either have a wide dynamic range with a nearly continuous set of permitted values, such as the choice of a number from 1 to 1,000, or it can be less continuous and/or subsume a narrower dynamic range. In this example, stake selection is limited to 5, 25 or 100 crowns, as these values are easy to visualize and the step-up, on an exponential scale, is nearly linear. In addition, the narrow range also serves to level the playing field between participants who start the session with a substantial amount of crowns, and those who started with relatively few crowns in each session.

The reinforcement value of increasing one's currency holding has been established by providing a monetary prize for the best result in each game as well as prizes for the top performers, in terms of aggregated results, in a series of games played over a period of time. For example, a prize of $50 dollars is awarded for the best performance in each game, and a prize of $1,000 is awarded for the best performance during an entire month.

Input module 38 receives the participant's stake and increments the selected stake to a pool 502 having stakes from other participants, and decrements the selected stake from the participant's own crown total 504, at step 408. At step 410, feedback module 44 receives the participant's predicted move and registers it as a move prediction event and calculates the elapsed time between the prompt and the move prediction event. Next, in step 412 feedback module 44 determines whether the predicted move event occurred before the move by expert player B. When the predicted move event occurs after the move by expert player B then stake is returned to the participant and the pool total is decremented by the stake amount initially selected by the participant (414) and the participant waits for the next prompt to predict a move (step 404). However, if the predicted move event occurs before the move by expert player B the feedback module 44 determines whether the predicted move is identical to the move by expert player B (step 416).

When the predicted move is not identical to the move by expert player B then feedback module 44 determines whether all of the other participants failed to predict the move by expert player B too (step 418). When all of the other participants failed to predict the move by expert player B then all of the participants' stakes for that move are returned to the respective participants (step 420), and the pool total is decremented accordingly, else the participant's crown total is decremented by an amount corresponding to the selected stake amount for that move (step 422), and the participant waits for the next prompt to predict a move (at step 404).

When the predicted move is identical to the move by expert player B then feedback module 44 determines whether all of the other participants predicted the move by expert player B too (step 426). When all of the other participants predicted the move by expert player B then all of the participants' stakes for that move are returned to the respective participants (step 428), and the pool total is decremented accordingly, else feedback module 44 divides the pool total in proportion to the participant's stake amount for that move and increments the participant's crown total (step 430). Next, activity module 40 determines whether the game is over (step 432), and if the game is over then activity module 40 determines each participant's performance and compiles game statistics for each participant to determine particular prizes for certain participants (step 434). For example, one particular prize is awarded to the participant with the highest number of successful predicted moves in the game, while other prizes are awarded at the end of predetermined time period, such as at the end of each month, for the most successful participants. If, in step 432, it is determined that the game is still in progress, then steps 404 to 432 are repeated (step 436).

FIGS. 8a to 8d show exemplary progressive stages or moves in a chess game. In FIG. 8a, in message window 140 the participant chooses a stake, such as 25 crowns by enabling radio button 500, and the stake of 25 crowns is displayed 502 and the participant is prompted to play for expert player B (White) 504. Activity module 40 provides hints 506 to all participants, and does not provide any particular participant with a competitive advantage, and therefore hints are provided for educational purposes, and to trigger the participant to think strategically. Subsequently, prior to a move by the expert player the participant predicts the move by the expert player to be White Knight from d3 to e5, as shown in FIG. 8b at 600, and the assigned stake is 25 crowns, as shown at 602. The crown pool total from all of the stakes by all participants is 265 crowns, as shown at 604. In FIG. 8c, the expert player then makes a move by placing White bishop from f4 to d6 and the expert player's move is recorded and shown below message window 140, as White bishop xd6, at 700. The feedback module 44 compares the participant's predicted move to the expert player's move, and determines that the participant's predicted move was different from the expert player's move. Next, after feedback module 44 determines some participants (7 participants) managed to predict the correct move then the pool of 265 crowns is divided among the 7 winner in proportion to their stakes, as shown at 702. Meanwhile, feedback module 44 displays a message “You lost” 704 to the participant, next to the participant's predicted move 706, and the participant's total crown count is decremented accordingly, at 708. All the moves made by experts A, B from the start of the game to the end of the game are itemized and shown below message window 140, and can be reviewed after the game. FIG. 8d shows a screenshot in which a participant has won some crowns, following a successful outcome on a predicted move, at 800.

In another exemplary embodiment, during a contest the participants are able to see the game played in chess game portion 94, and listen to live audio commentary on each position, or video commentary in game summary portion 100 on each position. In one example, the commentary is provided by at least one of a chess site administrator, a commentator, a participant and an expert. For instance, verbal instruction is represented by having one or more experts comment audibly on each position as it occurs. These experts provide information about the characteristics of each position, and also describe the thought processes they use to make their own determination of the best move to play next. Assimilation of some of this information, and internalization of some of these thought processes are an intended outcome of this training system. The exemplary game of chess also includes visual aids represented by displaying the calculations of a computer program that analyzes each position as it occurs. However, only a limited amount of information is displayed, requiring participants to still form their own conclusions about which move is most likely to succeed at each turn, that is, at each stage of the activity. In this exercise the participants choose moves for both black and white, not just for one side or the other, throughout the game. This emulates the way the training system operates in other disciplines, by requiring an ongoing stream of decisions to cope with a developing sequence of situations. Even in this training system, the scenarios are generally unexpected because they result from moves played by experts, which differ from the moves attempted by most of the participants, most of the time.

In another exemplary embodiment, following the conclusion of a game the participant is provided with an option to review the game. In general, after a game ends the players share the board, and both can navigate back and forth and even enter new moves, and all of the participants are able to follow along. The expert commentators (or others) may be invited to share the board in order to join in the game review. At any point during the game review the original game played may be restored. Furthermore, other previously-played games may be imported for review by the players and/or commentators.

In yet another embodiment, spectators or non-participants can also view the training session and listen to the audio commentary. Once the training session is over the spectators can participate in the analysis or review of the training session with the participants, expert players, and/or commentators. The post-session review and analysis assists the spectators and participants to understand the thought process and reasoning behind the expert players' decisions.

In another exemplary embodiment, a player can receive extra time to play each move. Extra time is added to the player's clock each instance the player plays a move, such that the player benefits from the additional time. In the “Increment” embodiment, all of the extra time is added to the player's clock. However, in the “Delay” embodiment, if the player delays making a move, the player's clock counts down the extra seconds before starting to decrease the player's time. Delays cannot accumulate from move to move.

In another embodiment, the currency can either be a real-world currency such as US Dollars or British Pounds, or it can be a purely representative currency (such as “gold stars” that might be used with children), or it can be representative, but also exchangeable, at some rate, for a real-world currency or something else of tangible value. Accordingly, input module 42 relies on a currency definition and provides the stake selection and decision selection mechanisms. The training system 30 defines a currency for use both in expressing confidence in a decision, and in providing feedback for correct and incorrect decisions. The purpose of the currency, and of the ways in which it is won or lost, is to reinforce an emotional investment in the decision-making process, which is intended to strengthen focus on the training and improve results both at learning the information presented, and also at internalizing the thought processes that enable success in the primary activity. Units of the currency are lost when an incorrect decision is made, and the stake is thereby forfeited. On the other hand, units of the currency can be won by executing correct decisions. Overall performance in a training session is measured as the “delta”, or difference, between a participant's currency balance at the end of a training session, compared to his starting balance at the beginning of that session.

One or more of the components and/or one or more additional components of the example environment of FIG. 2 may each include memory for storage of data and software applications, a processor for accessing data and executing applications, and components that facilitate communication over a network. In some implementations, the components may include hardware that shares one or more characteristics with the example computer system that is illustrated in FIG. 1.

Databases 50, 52, 54 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), NoSQL databases such as MongoDB, couchbase or couchDB, or a storage area network (SAN), Microsoft Access™ or others may also be used, incorporated or accessed in the invention. Alternatively, databases 50, 52, 54 are communicatively coupled to application server 32.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, solid state drives, or any other medium which can be used to carry or store desired program code means in the form of computer-executable instructions and/or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, user, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. An interactive training system for at least one participant, said system comprising:
an activity module for generating at least one training session based on a primary activity performed by at least one expert;
an environment module for providing at least one training scenario for said primary activity;
an input module for enabling said at least one participant to register an expectation of said at least one expert's decision, including a stake corresponding to his degree of confidence in said expectation;
a feedback module for providing feedback to said at least one participant regarding said expectation said at least one participant enters or fails to enter; and for determining a reward or penalty based on said expectation.

2. The interactive training system of claim 1, wherein said at least one training scenario comprises at least one of visual training aids associated with said primary activity, verbal training aids associated with said primary activity, and instructional materials associated with said primary activity.

3. (canceled)

4. (canceled)

5. The interactive training system of claim 2, wherein said at least one training scenario portrays historical actions associated with said primary activity, wherein said historical actions represent actions taken by said at least one expert or another at least one participant faced with a similar said at least one training scenario.

6. (canceled)

7. (canceled)

8. The interactive training system of claim 5, wherein said at least one training scenario comprises at least one of images, audio and video, and wherein said at least one training scenario comprises at least one of computer-generated content, simulated content, enacted content, pre-recorded content, live content, and streamed content.

9. (canceled)

10. The interactive training system of claim 8, wherein said streamed content is associated with at least one of current events, real-time events, near real-time events and historical events.

11. (canceled)

12. The interactive training system of claim 10, wherein said scenario comprises a sequence of related situations, and
wherein each of said situations comprises a decision stage where said at least one participant is able to formulate a response, perform an action or make a decision.

13. The interactive training system of claim 12, wherein at least one of said visual training aids, said verbal training aids, said instructional materials and said historical actions assist said at least one participant in formulating said response, performing said action or making said decision.

14. The interactive training system of claim 13, wherein said at least one participant assigns said stake to said response, said action or said decision, wherein said stake is representative of a confidence level of said at least one participant in said response, said action or said decision; and
wherein said at least one participant assigns said stake and submits said response, performs said action or make said decision before expiration of an allotted time, else said expectation is not registered.

15. (canceled)

16. The interactive training system of claim 14, wherein a comparison is performed between at least one of said response, said action or said decision by said at least one participant and a corresponding response, action or decision by said at least one expert; wherein said allotted time is a time period in which said at least one expert's decision is received; and
wherein an outcome from said comparison is one of a passive outcome and a negative outcome.

17. (canceled)

18. The interactive training system of claim 16, wherein said positive outcome corresponds to an instance where said at least one of said response, said action or said decision by said at least one participant matches said corresponding response, action or decision by said at least one expert;
wherein said positive outcome causes a determination of a reward for provision to said at least one participant;
wherein said reward is commensurate with a level of difficulty associated with formulating said response, performing said action or making said decision for said situation; and
wherein said reward is commensurate with said stake.

19. (canceled)

20. (canceled)

21. (canceled)

22. The interactive training system of claim 18, wherein when a plurality of participants are participating in said at least one training scenario, said stake of each of said plurality of participants is placed in a pool, and said reward is divided among said plurality of participants that experience said positive outcome, unless each of said plurality of participants experiences said positive outcome;
wherein each of said plurality of participants receives a split reward based on said pool; and
wherein said split reward is in proportion to said stake.

23. (canceled)

24. The interactive training system of claim 22, wherein when a plurality of participants are participating in said at least one training scenario, said stake of each of said plurality of participants is placed in a pool, and if only one of said plurality of participants experiences said positive outcome, then said reward is provided to only one of said plurality of participants; and
wherein when a plurality of participants are participating in said at least one training scenario, said stake of each of said plurality of participants is placed in a pool, and each of said plurality of participants experiences said positive outcome, then said stakes are returned to each of said plurality of participants and no reward is provide to any of said plurality of participants.

25. (canceled)

26. (canceled)

27. (canceled)

28. The interactive training system of claim 17, wherein said negative outcome corresponds to an event where said at least one of said response, said action or said decision by said at least one participant is different from said corresponding response, action or decision by said at least one expert; and wherein said negative outcome causes a determination of said penalty for issuance to said at least one participant
wherein said penalty is commensurate with a level of difficulty associated with formulating said response, performing said action or making said decision for each of said situations;
wherein said penalty is commensurate with said stake; and
wherein when a plurality of participants are participating in said at least one training scenario, and each of said plurality of participants experiences said negative outcome, then said penalty is not issued.

29. (canceled)

30. (canceled)

31. (canceled)

32. (canceled)

33. (canceled)

34. (canceled)

35. (canceled)

36. (canceled)

37. (canceled)

38. (canceled)

39. The interactive training system of claim 22, wherein a prize is provided to said at least one participant having at least one of the most positive outcomes in said at least one training session, the most positive outcomes in a predetermined number of said at least one training sessions is provided with a prize; and the most said at least one training sessions within a predefined time frame.

40. (canceled)

41. (canceled)

42. (canceled)

43. (canceled)

44. (canceled)

45. (canceled)

46. An interactive training system for at least one participant, said system comprising:
an activity module comprising a second set of program instructions executable by a processor to cause said processor to generate at least one training session based on a primary activity performed by at least one expert;
an environment module comprising a first set of program instructions executable by a processor to cause said processor to provide at least one training scenario for said primary activity;
an input module comprising a third set of program instructions executable by a processor to cause said processor to enable said at least one participant to register an expectation of said at least one expert's decision, including a stake corresponding to his degree of confidence in said expectation;
a feedback module comprising a fourth set of program instructions executable by a processor to cause said processor to provide feedback to said at least one participant regarding said expectation said at least one participant enters or fails to enter; and to determine a reward or penalty based on said expectation and said stake.

47. A computer-implemented method for training at least one participant in an activity, said method comprising:
generating at least one training session based on an activity performed by at least one expert;
providing at least one training scenario for said activity;
enabling said at least one participant to register an expectation of said at least one expert's decision, including a stake corresponding to his degree of confidence in said expectation;
providing feedback to said at least one participant regarding said expectation said at least one participant enters or fails to enter; and
determining a reward or penalty based on said expectation and said stake.

48. The method of claim 47, wherein said at least one training scenario comprises at least one of visual training aids associated with said primary activity: verbal training aids associated with said primary activity; instructional materials associated with said primary activity; and wherein said at least one of said visual training aids, said verbal training aids, said instructional materials and said historical actions assist said at least one participant in formulating said decision.

49. The method of claim 48, wherein said at least one training scenario portrays historical actions associated with said primary activity, wherein said historical actions represent actions taken by said at least one expert or another at least one participant faced with a similar said at least one training scenario.

50. The method of claim 49, wherein at least one of said visual training aids, said instructional materials and said historical actions is presented visually or auditorily; and wherein said at least one training scenario comprises at least one of images, audio and video.

51. (canceled)

52. (canceled)
53. The method of claim 47, wherein said at least one training scenario comprises a sequence of related situations, and wherein each of said situations comprises a decision stage where said at least one participant is able to formulate a response, perform an action or make a decision; wherein said at least one participant assigns said stake and submits said response, performs said action or make said decision before expiration of an allotted time, else said expectation is not registered.

54. (canceled)

55. The method of claim 53, comprising a further step of comparing said decision by said at least one participant to a corresponding decision by said at least one expert, and wherein an outcome from said comparison is one of a positive outcome and a negative outcome;
wherein said allotted time is a time period in which said at least one expert's decision is received.

56. The method of claim 55, wherein said positive outcome corresponds to an instance where said decision by said at least one participant matches said corresponding decision by said at least one expert;
wherein said positive outcome causes a determination of a reward for provision to said at least one participant, wherein said reward is commensurate with at least one of a level of difficulty associated with formulating decision for each of said situations, and said stake; and
when a plurality of participants are participating in said at least one training scenario, said stake of each of said plurality of participants is placed in a pool, and said reward is divided among said plurality of participants that experience said positive outcome, unless each of said plurality of participants experiences said positive outcome.

57. (canceled)

58. (canceled)

59. The method of claim 55, wherein said negative outcome corresponds to an event where said at least one of said decision by said at least one participant is different from said corresponding decision by said at least one expert;
wherein said negative outcome causes a determination of said penalty for issuance to said at least one participant;
wherein said penalty is commensurate with at least one of a level of difficulty associated with formulating said decision for each of said situations and said stake.

60. (canceled)

61. (canceled)

62. The method of claim 55, wherein when a plurality of participants are participating in said at least one training scenario, and each of said plurality of participants experiences said negative outcome, then said penalty is not issued.

63. (canceled)

64. (canceled)
